(19) United States
(12) Patent Application Publication
(10) Pub. No.: US 2003/0028536 A1
(43) Pub. Date: Feb. 6, 2003

(54) Proactive emergency response system

(76) Inventors: Hartej P. Singh, Livingston, NJ (US); Manu Jetley, North Caldwell, NJ (US); Vincent Tortoriello, West Caldwell, NJ (US)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/080,761

(22) Filed: Feb. 22, 2002

Related U.S. Application Data
(60) Provisional application No. 60/271,887, filed on Feb. 27, 2001.

(51) Int. Cl. G06F 7/00

(52) U.S. Cl. 707/10

(57) ABSTRACT

A system and method for dispatching emergency services personnel and equipment are provided. The system includes a central server, a dispatcher terminal and a plurality of mobile data terminals (MDTs) associated with the emergency services personnel and equipment. The central server processes incoming calls for emergency services and outgoing messages from the dispatcher terminal. Based upon the dispatching message for the incoming call, the central server automatically queries a plurality of databases in accordance with a predetermined set of rules for information relevant to the emergency and the dispatched personnel and equipment. Based upon the information received, the central server automatically transmits appropriate messages and warnings to the MDTs traveling to the site of the emergency and queries the databases further using further predetermined rules. Additional messages and warnings are transmitted to the MDTs based upon the further information received.

### CROSS-REFERENCE TO RELATED APPLICATIONS

The present invention claims the benefit of U.S. Provisional Patent Application No. 60/271,887 filed on Feb. 27, 2001, the entire disclosure of which is incorporated herein in its entirety.

### BACKGROUND OF THE INVENTION

The present invention relates generally to information systems, and in particular, to computer aided dispatch (CAD) systems.

CAD systems typically employ a central dispatcher and a plurality of mobile data terminals (MDTs) within each vehicle. Each data terminal can transmit and receive data from the dispatcher over a wireless network. Personnel using the vehicles can receive calls for service assignments, view maps indicating the location of a particular destination and the locations of other vehicles within the system. In the case of a CAD system for a police department, officers using the MDTs are able, for example, to verify the status of registration plates and licenses, to determine whether a vehicle is stolen and to determine whether a person detained has a criminal record.

Using satellite-based automatic vehicle locating (AVL) systems such as the global positioning system (GPS) or other technologies, CAD systems can display on the MDTs detailed maps of their operating areas indicating the location of a destination. When a call is received at the central dispatching station, a dispatcher using the AVL system can tell which emergency vehicle is able to provide the quickest response to the call. In the case of a CAD system used to dispatch police officers, for example, an officer using an MDT can query criminal databases maintained by state and federal law enforcement agencies for information regarding, for example, a registration plate or driver's license or to determine if active warrants exist for a person. MDTs also can receive instructions from the central dispatcher and transfer information and messages back to the dispatcher.

CAD systems are not limited to law enforcement. Other services such as fire, emergency medical services, utility repair crews, messenger services, parcel delivery services, etc. can use CAD systems.

The central figure in a typical CAD system is the call-taker or dispatcher (often the same person). A flow diagram of a typical system is shown in FIG. 1. The process begins at step 100 with a call-taker receiving a call for service. Information such as the name of the caller, the nature of the emergency, the address of the emergency, the time, etc., is recorded to form a unique caller's record at step 104. Some information, typically the caller's name and address from the telephone company's records, is displayed to the call-taker automatically using, for example, caller ID or computer telephone integration (CTI). Most information must be manually entered, however, by the call-taker.

For example, if the call for service is made from a cellular telephone, a cellular telephone locating system may provide the location of the caller and caller ID may provide the name of the telephone's owner. The dispatching location may be unrelated, however, to the caller or the caller's location. The call-taker works with the CAD system to assist in capturing the information conveyed during the call. The call-taker must evaluate the information and use his or her judgment to determine the best way to respond and what information is necessary to assist in the response.

Referring again to FIG. 1, at step 110, the caller's record is passed to a dispatcher (if the call-taker is different from the dispatcher) who dispatches a vehicle or person nearest to the dispatching location using a wireless data communication link to the MDT of the vehicle or person. The dispatcher also may manually query specific databases to collect additional information based upon the nature of the call. In addition, at step 120, dispatched units may request additional information regarding the call from the dispatcher or by querying the databases themselves via the MDT. In most instances, however, the dispatched vehicle or person arrives at scene with only the information obtained from the dispatcher. Information such as, in the case of emergency services personnel, the presence of guns, dogs or hazardous chemicals present at the location or arrest records, behavioral problems, medical problems, etc. of persons at the location, often are not provided.

More specifically, in prior art CAD systems used to dispatch emergency services personnel, the emergency services personnel or the dispatcher may query certain databases via the MDT or the dispatcher's terminal, respectively, and retrieve information pertinent to the call. In many cases, however, the information which the emergency services personnel or dispatcher consider to be pertinent is not the most relevant information. A query based on the experience of the emergency services personnel or dispatcher, moreover, often results in a plethora of information that the emergency services personnel have no time to study. Emergency services personnel, moreover, often travel to the location of a call as quickly as possible and, therefore, have little or no time to issue query requests or review the responses. Arriving at a call-for-service (CFS) destination without full knowledge of the situation, however, may limit the effectiveness of the response and, more importantly, jeopardize the safety of the responding individuals.

Present CAD systems simply automate the manual practices of the past. The systems do not effectively and efficiently utilize available technologies and databases to support, and reduce the risks to, responding personnel. A need exists, therefore, for a CAD system and method fully utilizing such technologies and databases. In particular, a need exists for a CAD system that reacts proactively to reduce the risks to emergency services personnel without requiring that such personnel, or the dispatcher, take action to request such assistance.

### SUMMARY OF THE INVENTION

The present invention provides a computer aided dispatching system. The dispatching system includes a central server in wireless communication with a mobile data terminal associated with a person or vehicle. The central server is adapted to receive a communication associating the person or vehicle with a location for providing services at the location, to select, in response to the communication, a set of rules corresponding to the services, to query a database based upon the rules for information relevant to the services and the location and to automatically transmit messages corresponding to the relevant information wirelessly to the mobile data terminal. The central server preferably is adapted to transmit the messages while the person or vehicle is in route to the location.

The dispatching system preferably is associated with a municipality, and the services preferably are the services of the municipality's emergency services personnel, for example, the municipality's police personnel, fire personnel or medical personnel. The mobile data terminal preferably is located in the vehicle, or mounted on the person, and includes a display to display the messages to the person or to a driver or passenger of the vehicle. The mobile data terminal preferably also includes an audio synthesizer or audio simulator adapted to provide an audio reproduction of the messages for the person or the driver or passenger.

The communication associating the person or vehicle with the location for providing services may be a signal from a dispatching terminal, in communication with the central server, to the mobile data terminal dispatching the person or vehicle to the location. In the alternative, the communication may be a signal from the mobile data terminal to the dispatching terminal indicating that the person or vehicle is traveling, or will travel, to the location for providing the services. In yet a further alternative, the communication may be a telephone call to the dispatching terminal requesting the services.

The central server preferably is further adapted to select a second set of rules, corresponding to the relevant information, to query the database further based upon the second set of rules for further information relevant to the relevant information and to automatically transmit further messages corresponding to the further relevant information wirelessly to the mobile data terminal. The central server preferably is adapted to also transmit these further messages while the person or vehicle is en route to the location.

The database preferably comprises a plurality of different databases separately maintained by different entities and connected by a network, for example, the Internet. The entities preferably are departments or agencies of a municipality with which the dispatching system is associated, for example, the police department, fire department, emergency medical services department, animal control department, health department, tax department, public works department, hazardous materials department, prosecutor's office, sheriff's office and municipal court. The database preferably also includes databases separately maintained by different departments or agencies of the federal government, for example, the database of the National Crime Information Center, and databases of the state in which the municipality is located.

The mobile data terminal preferably includes a geographical locating device adapted to identify the geographical position of the mobile data terminal and to transmit a signal providing the geographical position to the central server. The central server preferably is adapted to provide the geographical position to the dispatching terminal. In the alternative, the central server is adapted to automatically dispatch the mobile data terminal to the location if the mobile data terminal is included among a group of other mobile data terminals associated with the dispatching system and the geographical position indicates that the mobile data terminal is closer to the location than the other mobile data terminals.

The present invention also provides a method of dispatching a person or vehicle. The method includes (1) receiving at a central server a communication associating the person or vehicle with a location for providing services, (2) selecting from the central server, in response to the communication, a set of rules corresponding to the services, (3) querying from the central server a database based upon the rules for information relevant to the services and the location, and (4) automatically transmitting from the central server messages corresponding to the relevant information wirelessly to a mobile data terminal associated with the person or vehicle.

They present invention also provides a computer readable medium having computer executable software code stored on the medium. The code includes instructions for causing a central server of a dispatching system to perform the steps of (1) receiving a communication associating a person or vehicle with a location for providing services, (2) selecting in response to the communication a set of rules corresponding to the services, (3) querying a database based upon the rules for information relevant to the services and the location, and (4) automatically transmitting messages corresponding to the relevant information wirelessly to a mobile data terminal associated with the person or vehicle.

### BRIEF DESCRIPTION OF THE DRAWINGS

FIG. 1 depicts a typical process for a prior art CAD system.

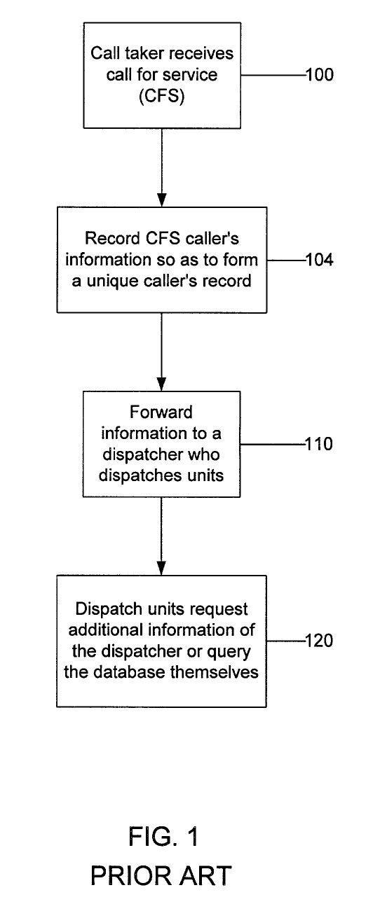

FIG. 2A depicts a CAD system in accordance the present invention.

FIG. 2B further illustrates the CAD system of FIG. 2A.

FIG. 3A illustrates an exemplary data flow diagram of a CAD system in accordance with the present invention.

FIG. 3B illustrates software modules and associated process flows for a CAD system in accordance with the present invention.

### DETAILED DESCRIPTION OF PREFERRED EMBODIMENTS

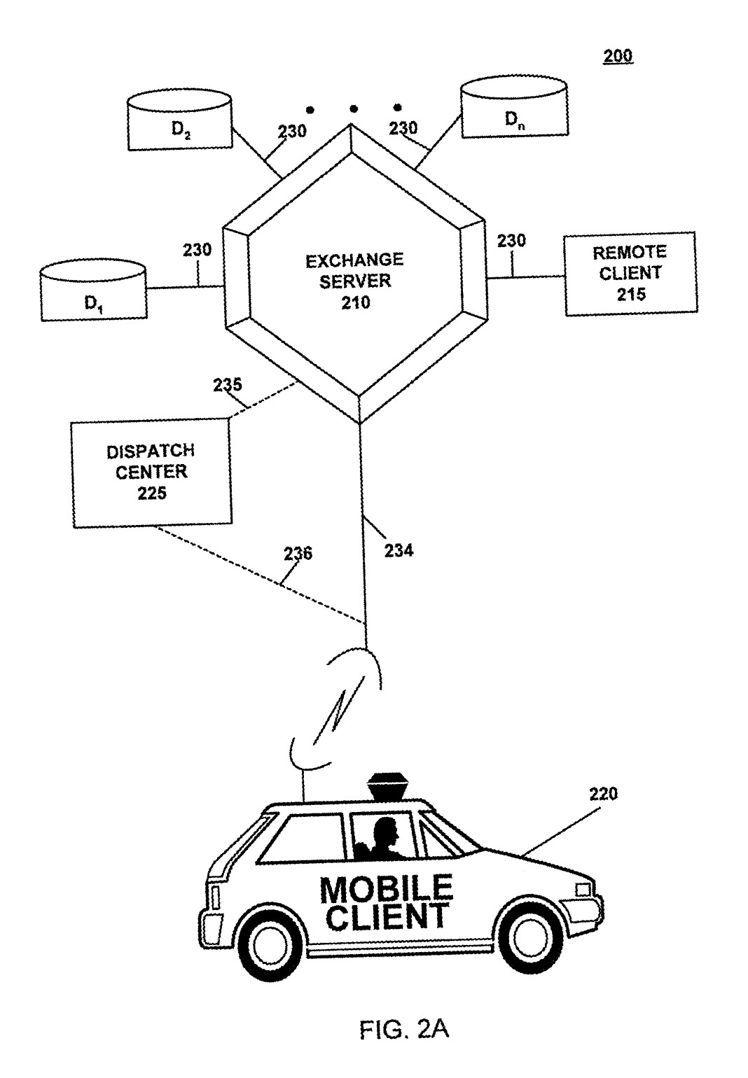

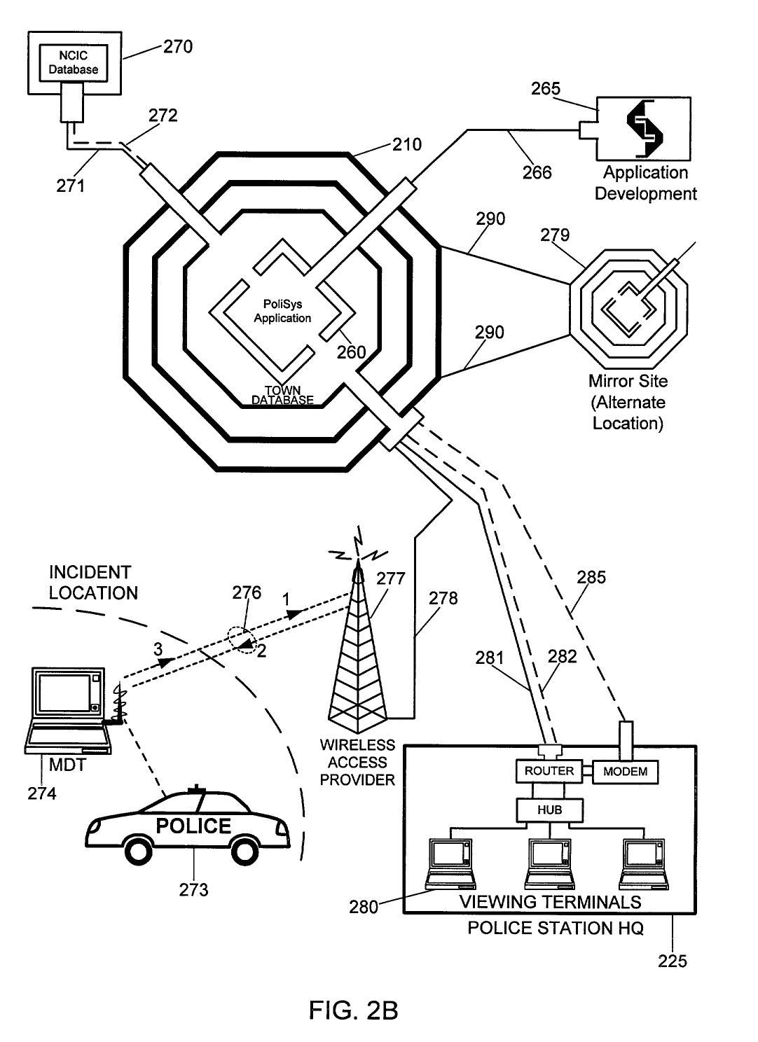

A CAD system 200 in accordance with the present invention is shown in FIG. 2A. CAD system 200 is used for dispatching emergency services personnel and vehicles for a municipality. System 200 could be used for other purposes, however, for example, dispatching vehicles and persons for delivery services or repair services.

As shown in FIG. 2A, CAD system 200 includes exchange server 210 in communication with a plurality of databases, namely, databases D1, D2 through DN, one or more remote clients 215, one or more mobile clients 220 (for example, a police officer or a police vehicle) and a dispatch center or dispatcher 225. In a typical situation, system 200 includes numerous remote clients 215 and mobile clients 220. Exchange server 210 communicates with the databases and the remote client 215 through network links 230. Network links 230 may include, for example, a public switched telephone network, a wide area network, a local area network or any other network through which data may be exchanged. Exchange server 210 may include one or more server computers, personal computers, mainframe computers and other computers or processing devices.

Exchange server 210 communicates with mobile client 220 over wireless link 234. Mobile client 220 typically is an emergency response vehicle, such as a police vehicle, ambulance or fire vehicle with a wireless connection to communicate with dispatch center 225 or exchange server 210. On the other hand, mobile client 220 may be, for example, an officer on foot patrol equipped with a wireless device, e.g., a personal digital assistant (PDA), two-way pager, cell phone with messaging capability, or a laptop computer using wireless link 234 to communicate with either dispatch center 225 or exchange server 210.

As shown in FIG. 2A, dispatch center 225 may serve as a point of interconnection between mobile client 220 and exchange server 210 via link 235 and wireless link 236. Mobile client 220 may communicate directly with exchange server 210 via wireless link 234 our through dispatch center 225 through wireless link 236 and link 235. Link 235 is similar to network links 230 and can be implemented using any of the systems for devices described above for network links 230. In a preferred embodiment, link 235 is a T1 line traversing the public switched telephone network.

Dispatch center 225 may be at the same location as exchange server 210. On the other hand, as indicated in FIG. 2A, dispatch center 235 and exchange server 210 may be at separate locations. Notwithstanding their locations, mobile client 220 has a communication path, via wireless link 236 and link 235, to exchange server 210 through dispatch center 225. In fact, since dispatch center 225 usually will reside in a local municipality or precinct, mobile client 220 usually communicates with exchange server 210 through dispatch center 235. In many cases, municipalities will choose to share the expenses associated with exchange server 210. As a result, exchange server 210 may be located at a location central to a number of municipalities or other governmental organizations to facilitate maintenance and organization through, for example, an application service provider (ASP).

Remote client 215 typically is a personal computer running a web browser application or any other application capable of providing remote client 215 access to databases D1, D2 through DN via exchange server 210. Remote client 215 generally is located in a municipality or agency separate from the municipalities directly served by exchange server 210. For example, exchange server 210 may be located in a municipality in New Jersey, and remote client 215 may be located at the FBI's headquarters in Virginia. As result of the communication links connecting remote client 215, dispatch center 225 and mobile client 220, exchange server 210 and databases D1, D2 through DN, information entered into any of these databases by any computer or other data processing device connected to CAD system 200 is immediately available to all other computers and data processing devices connected to the system. Information entered by remote client 215, therefore, regardless of the client's location, is immediately available to mobile client 220. For example, if mobile client 220 is a municipal police officer in an automobile with an MDT, he or she is able to gather the most recent federal information on a local activity from a remote location such as the FBI.

In accordance with the present invention, mobile client 220 automatically receives relevant information from databases D1, D2 through DN via exchange server 210 upon being dispatched to a location without mobile client 220 initiating queries for the information. Emergency service personnel, therefore, can focus upon the task immediately at hand, namely, reaching the emergency as quickly and safely as possible and dealing with the emergency without worrying about formulating queries for dispatch center 225 or exchange server 210 to obtain necessary information. The emergency service personnel nevertheless are provided all information needed to deal with the situation including information which is unexpected and unlikely to be requested.

Exchange server 210 includes a local database for storing resident programs and data on specific incidents. Exchange server 210 runs transactional database management software such as Microsoft®, SQL-server, Oracle® and the like. By using such software, information residing in variously structured databases can be accessed.

Remote client 215 may interact with exchange server 210 using various protocols. For example, remote client 215 may log onto exchange server 210 via client software residing in remote client 215. The client software may include for example, a browser application such as Netscape Navigator®, Microsoft Internet Explorer® or other middleware which communicates with exchange server 210 over the Internet using the hypertext transfer protocol language (“HTTP”) or extensible markup language (“XML”). In the alternative, clients may communicate with exchange server 210 via cellular telephones, pagers, handheld computing devices, touchtone telephones, etc.

CAD system 200 is further illustrated in FIG. 2B. As shown in this figure, exchange server 210 runs application 260. Application 260 preferably is the PoliSys^{SM} application program but can be any other suitable application program. Of course, exchange server 210 also may run numerous other applications. Application 260 resides in exchange server 210 and communicates with application development site 265 via a virtual private network connection 266. Application 260 also is connected to the National Crime Information Center (NCIC) database 270 or the records of the Federal Bureau of Investigation (FBI) via a secure point-to-point line 271 and a backup secure line 272. Secure lines 271 and 272 may be, for example, T1 lines. MDT 274, which may reside in police vehicle 273 or any other vehicle dispatched by CAD system 200, communicates with application 260 over a secure wireless link 276 provided by wireless provider 277. Police car 273 also includes a GPS receiver in communication with MDT 274. Wireless provider 277 is directly coupled to exchange server 210 through a secure point-to-point line 278.

Application 260 is duplicated (mirrored) at mirror site 279 to facilitate disaster recovery. Mirror site 279 is connected to network server 210 via two secure lines 290. Application 260 also is connected to dispatcher terminal 280 in dispatcher center 225 via a secure point-to-point line 281 and backup secure line 282. Application 260 additionally is connected to dispatcher center 225 via a secure dial-up modem link 285 which may be useful for disaster recovery. Dispatcher center 225 may be located in, for example, a police station of a local municipality.

Application 260 is dedicated to the functioning of the police department. This application resides on a multitude of servers functioning as a unit. The application is capable of simultaneously handling numerous queries from remote browsers, processing these queries over a multitude of servers and accessing a plurality of databases. Exchange server 210 includes modular hardware components comprising processors and on-line and off-line storage. The software systems comprise a plurality of operating systems, application software, database software, data warehousing software, data mining software, communications software, security software (responsible for validating a client or enabling the client to access applications based on the client's identity from previously recorded privileges), etc. Application development company 265, e.g., Enforsys, Inc., periodically updates the systems, databases and software of exchange server 210.

In operation, application 260 operates proactively in response to a call for emergency services. For example, in response to such a call, a dispatcher using dispatcher terminal 280 captures the caller's name and address from the telephone company's records for the telephone number from which the call was made. This information is transmitted to exchange server 210. In response, exchange server 210, running application 260, retrieves relevant records relating to this name and address and, using the automatic vehicle locating system in the municipality's emergency vehicles (for example, GPS or systems using triangulation of cellular telephone base stations), dispatches to the address the nearest emergency vehicle, for example, police car 273, by transmitting instructions to wireless MDT 274 using wireless provider 277. As police car 273 approaches the location, exchange server 210 automatically delivers to MDT 274 data from the federal, state and municipal records for the location, or with respect to individuals residing at the location, which may be important to the emergency service personnel. Of course, in addition to such information transmitted to MDT 274 proactively, information also may be transmitted to the MDT 274 in response to a specific request from the MDT. Upon receiving the information, MDT 274 flashes appropriate messages on its display screen or provides an audio reproduction of the information using a voice simulator or voice synthesizer. For example, if the municipal records indicate that a dog is present at the location to which the emergency services personnel have been dispatched, exchange server 210 transmits this information to MDT 274, and MDT 274 flashes this information on its display screen (or, as indicated above, produces a synthesized or simulated audio reproduction of the information). Similar information is provided on the basis of searches of the federal and state records for the location and the individuals residing at the location, for example, gun licenses, criminal records, motor vehicle records, records of domestic violence, etc. No request for the information is required. Exchange server 210 provides the information automatically. The emergency service personnel need only focus on proceeding to the location as quickly and safely as possible.

After arriving at the location, information with respect to actions taken by the emergency service personnel in response to the call is transmitted from MDT 274 back to exchange server 210. For example, the responding police officer may wirelessly transmit a report on the incident to exchange server 210 using MDT 274. MDT 274, or exchange server 210, may automatically include in this report the data automatically transmitted to MDT 274 while en route to the location. This report also may be wirelessly transmitted directly to police headquarters and, if appropriate, the MDTs of other emergency vehicles. All reporting requirements on the incident, therefore, may be completed at the location. As a result, the responding officers are not required to return to police headquarters and can remain in the field where they are needed.

In addition to responding proactively to emergency calls, application 260 performs numerous other functions. For example, for a municipality's police department, a module of application 260 automatically determines the schedules of police officers based on predetermined rules. Another module maintains the time and attendance records for the officers. Yet another module maintains vehicle logs and prompts responsible personnel when maintenance is due on the vehicles. Yet another module integrates the police department's requisition records with the municipality's financial database.

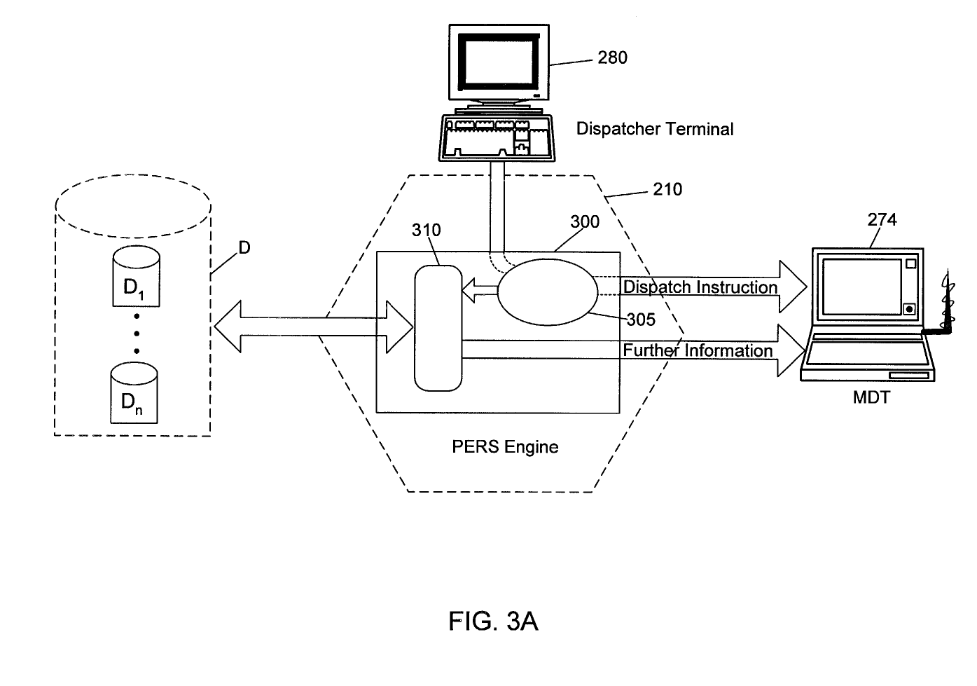

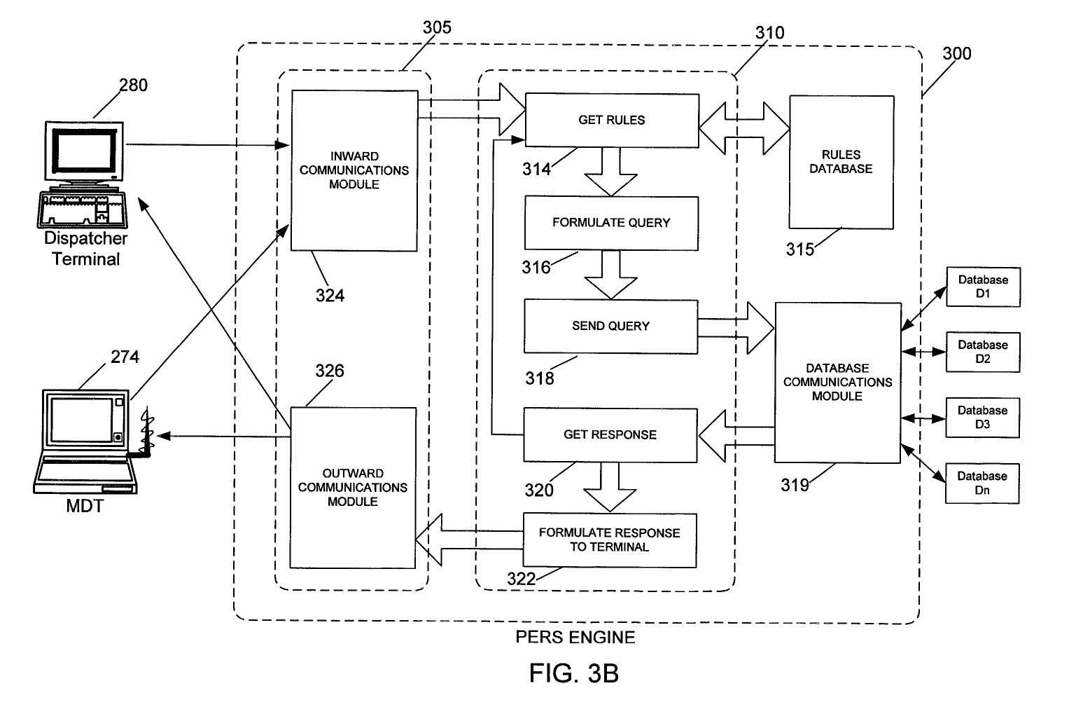

Turning now to FIG. 3A, an exemplary data flow diagram of the functional elements of exchange server 210 is illustrated. As shown in this figure, the heart of exchange server 210 is proactive emergency response (PERS) engine 300. PERS engine 300 includes response engine 305 and rules engine 310. These engines preferably are implemented in software. In the alternative, these engines may be implemented in hardware or a combination of hardware and software.

Response engine 305 provides information to dispatcher terminal 280 to assist the dispatcher in identifying the appropriate response to a call for emergency services. For example, response engine 305 queries the records of the telephone company in database D for the caller's name and address and information from GPS data for the appropriate emergency vehicles closest to the caller's location. This information is provided to the dispatcher to assist him or her in dispatching appropriate personnel and equipment to the scene. If the call reports a fire, for example, response engine 305 may consult records in database D providing information about the building to assist the dispatcher in dispatching appropriate fire vehicles.

Response engine 305 also is responsible for intercepting communications between dispatcher terminal 280 and a MDT, for example, MDT 274. Communications intercepted are transmitted to rules engine 310 which, in response, also queries database D. Database D includes databases D1, D2 through DN as illustrated in FIG. 3A. Rules engine 310 retrieves information from database D relevant to the communication in accordance with a predetermined set of rules applied by rules engine 310. Rules engine 310, or response engine 305, then automatically transmits the information retrieved to terminal 274. The predetermined set of rules applied by rules engine 310 are constructed to retrieve information from database D which may be important for emergency service personnel dealing with, or responding to, the particular situation.

The individual databases of database D, namely, D1, D2 . . . DN include the databases of, among other departments and agencies, the police department, fire department, department of fire prevention (including blueprints of buildings), emergency services, animal control, health department, tax assessor, tax collector, department of public works, department of hazardous materials (including material safety data sheets), prosecutor's office, sheriff's department, telephone company, municipal court, county court, state court, etc. These databases also include databases of federal agencies and institutions, including the FBI, the Bureau of Alcohol, Tobacco and Firearms (gun licenses) and the federal courts, and databases of private institutions including gun manufacturers and alarm companies.

In operation, if a person calls for emergency services, for example, the police to report an incident of domestic abuse, a dispatcher using dispatcher terminal 280 and information from response engine 305 dispatches a selected police vehicle associated with a MDT, for example, MDT 274. The dispatching message is transmitted to MDT 274 through PERS engine 300 and simultaneously forwarded by response engine 305 to rules engine 310. In the alternative, the call for emergency services itself, or selected portions of the call, can be converted to a digital form, transmitted through PERS engine 300 and forwarded by response engine 305 directly to rules engine 310.

Rules engine 310, based upon a predetermined set of rules governing the response of rules engine 310 for dispatching a police officer to the scene of reported domestic abuse (or a call reporting such abuse and requesting such dispatching), formulates a set of queries for the relevant databases D1, D2 . . . DN. For example, rules engine 310 may first query the records of the telephone company and tax assessor to determine the identity of the individuals residing at the location. Based upon these identities, rules engine 310 may then query all relevant databases for any criminal records of these individuals and any guns owned by these individuals. Based upon the location to which the police officer is dispatched, rules engine 310 also may query the records of the department of animal control to determine whether any dogs or other potentially dangerous pets reside at the location. Based upon the responses received, PERS engine 300 transmits an appropriate message to MDT 274 for visual display or audible reproduction, for example, “Beware of Dog,” “Gun on Premises,” “Male Resident Has Three Convictions For Domestic Abuse.” On the other hand, if the emergency is a fire to which the fire department has been dispatched, the messages may be, for example, “Hazardous Material On Site,” “Asbestos In Building,” “Building Has Six Floors,” “Building Constructed Of Wood.” Such information may be critically important to the responding emergency personnel and could save their lives. Since the information is provided automatically, the responding personnel can focus entirely on getting to the scene and dealing with the emergency.

The predetermined set of rules applied by rules engine 310 in response to any communication dispatching a police officer to a residential address may be, for example: (1) always check pet license database against occupant's name to determine if a pet is located on the premises; (2) always check pet license database against address to see if a pet is located on the premises; (3) always check gun license database against occupant's name to determine if a gun is located at the premises; (4) always check police department database against occupant's name to determine if the occupant has a criminal record. As the responses from each database are received, PERS engine 300, if appropriate, transmits corresponding messages to MDT 274. Based upon the nature of the responses from the databases, moreover, rules engine 310 develops additional queries for the same databases or other databases. For example, if the police department database indicates that an occupant of the premises has a state criminal record, rules engine 310 then may query the records of the FBI to determine whether the occupant has a federal criminal record. Also, if the pet license database indicates that a dog is located on the premises, rules engine 310 may query the pet license database further to whether any incidents previously were reported concerning the dog. The messages transmitted to MDT 274 may be conveyed in a single package but, more frequently, are transmitted sequentially during the officer's travel to the scene and, if appropriate, after his or her arrival. The responses also are transmitted to the dispatcher and displayed on dispatcher terminal 280. In response, the dispatcher may dispatch other personnel and equipment to the same address or search manually for information in the databases. If a wireless connection between exchange server 210 and MDT 274 is unavailable, the dispatcher may convey the information retrieved automatically by PERS engine 300, and also any information retrieved manually, to MDT 274 using a conventional radio transmission.

In the case of a communication dispatching a fire vehicle to a building fire, the predetermined set of rules applied by rules engine 310 may be, for example: (1) query database D for the records of the department of fire prevention for the presence of any hazardous materials and the blueprints of the building; (2) if hazardous materials are on the site, transmit message to responding MDT and dispatcher (who may dispatch a hazardous materials response unit); (3) query database D for more details on the hazardous materials; (4) if additional details are available (for example, composition, ingredients, hazard identifiers, first aid measures, fire fighting measures, accidental release measures, handling and storage procedures), transmit such information to responding MDT and hazardous materials unit if dispatched.

FIG. 3B further illustrates response engine 305 and rules engine 310 of PERS engine 210. As can be seen from this figure, response engine 305 includes inward communications module 324 and outward communications module 326, and rules engine 310 includes modules 314, 316, 318, 320 and 322 for, respectively, getting rules, formulating queries, sending queries and getting responses. Communications between dispatcher terminal 280 and MDT 274 are transmitted through inward communications module 324 and outward communications module 326 of response engine 305. Inward communications module 324 transmits these communications to module 314 of rules engine 310. Module 314, therefore, receives communications from both dispatcher terminal 280 and MDT terminal 274.

Based upon the nature of the communications to module 314 (for example, communication indicating that police vehicle is traveling to residential location of reported domestic abuse, communication dispatching fire vehicle to building fire, communication dispatching emergency medical vehicle to residential location of reported medical emergency), module 314 retrieves from rules database 315 a predetermined, corresponding set of rules for querying databases D1, D2, D3 . . . DN and transmits these rules to module 316. Module 316 applies these rules to formulate appropriate queries for these databases. This formulation includes identifying each relevant database and structuring queries for each database in the format appropriate to the database. The queries are transmitted to module 318 for transmission, via database communications module 319, to databases D1, D2, D3 . . . DN. The information obtained from the databases is retrieved, via database communications module 319, by module 320. Database communications module 319 translates, if necessary, the data from one format to another to facilitate communications between PERS engine 300 and particular databases. Module 320 transmits the retrieved information to module 322 and also back to module 314.

Depending upon the information, module 322 may transmit an appropriate message to MDT 274 and dispatcher terminal 280, for example, “Site Of Fire Is Storage Location For Hazardous Materials.” Also, depending upon the information, module 314 retrieves from rules database 315 a further predetermined set of rules for again querying databases D1, D2, D3 . . . DN and transmits these rules to module 316. In response, module 316 again applies the rules to formulate further queries for the databases (for example, what is the composition, ingredients, hazard identifiers, first aid measures, etc. for the hazardous materials) and transmits these queries to module 318 for transmission, via database communications module 319, to the databases. This process continues until all appropriate information is retrieved from the databases.

In general, the rules within rules database 315 are expressed in an abstract form, for example, an instruction such as: <check, [RECORD] against [DECISION SUPPORT DATA]>. Using such mnemonics, a substantial level of uniformity is achieved, and databases existing as stand-alone repositories in independent networks can be linked in a relational database.

The method of the present invention may be embodied in software executable by general-purpose or special-purpose computers. On the other hand, the method of the present invention may be implemented in hardware or a combination of hardware and software. The software may be stored on machine-readable media such as floppy disks, optical disks, CD-ROMs, magneto-optical disks, ROMs, RAMs, EPROMS, EEPROMS, magnetic cards, optical cards, etc., and transmitted to such medium electronically over an electronic communication network such as the Internet.

While the invention has been described in connection with preferred embodiments, one skilled in the art would find various changes and modifications obvious, and such changes and modifications are within the spirit and scope of the invention as defined by the following claims.

1. A computer aided dispatching system, comprising:
a central server in wireless communication with a mobile data terminal, said mobile data terminal being associated with a person or vehicle, said central server being adapted to receive a communication corresponding to a location for providing services, to select, in response to said communication, a set of rules corresponding to said services, to query a database based upon said rules for information relevant to said services and said location and to automatically transmit messages corresponding to said relevant information wirelessly to said mobile data terminal.

2. A computer aided dispatching system as in claim 1, wherein said central server is further adapted to transmit said messages while said person or vehicle is en route to said location.

3. A computer aided dispatching system as in claim 1, wherein said dispatching system is associated with a municipality and said services are services of the municipality's emergency services personnel.

4. A computer aided dispatching system as in claim 3, wherein said emergency services personnel are emergency services personnel selected from the group consisting of police personnel, fire personnel and medical personnel.

5. A computer aided dispatching system as in claim 1, wherein said mobile data terminal is located in said vehicle and said mobile data terminal includes a display adapted to display said messages to a driver or passenger of said vehicle.

6. A computer aided dispatching system as in claim 5, wherein said mobile data terminal further includes an audio synthesizer or audio simulator adapted to provide an audio reproduction of said messages for said driver or passenger.

7. A computer aided dispatching system as in claim 1, wherein said mobile data terminal is carried by said person and includes an audio synthesizer or audio simulator adapted to provide an audio reproduction of said messages for said person.

8. A computer aided dispatching system as in claim 7, wherein said mobile data terminal further includes a display adapted to display said messages to said person.

9. A computer aided dispatching system as in claim 1, wherein said communication is a signal from a dispatching terminal, in communication with said central server, to said mobile data terminal dispatching said person or vehicle to said location.

10. A computer aided dispatching system as in claim 1, wherein said communication is a signal from said mobile data terminal to a dispatching terminal, in communication with said central server, indicating that said person or vehicle is traveling, or will travel, to said location for providing said services.

11. A computer aided dispatching system as in claim 1, wherein said communication is a telephone call to a dispatching terminal, in communication with said central server, requesting said services.

12. A computer aided dispatching system as in claim 1, wherein said central server is further adapted to select a second set of rules, corresponding to said relevant information, to further query said database based upon said second set of rules for further information relevant to said relevant information and to automatically transmit further messages corresponding to said further relevant information wirelessly to said mobile data terminal.

13. A computer aided dispatching system as in claim 12, wherein said central server is further adapted to transmit said further messages while said person or vehicle is en route to said location.

14. A computer aided dispatching system as in claim 1, wherein said database comprises a plurality of independent databases separately maintained by different entities and connected by a network.

15. A computer aided dispatching system as in claim 14, wherein said network comprises the Internet.

16. A computer aided dispatching system as in claim 3, wherein said database comprises a plurality of different databases separately maintained by different departments or agencies of said municipality.

17. A computer aided dispatching system as in claim 16, wherein said different departments or agencies comprise a plurality of departments or agencies selected from the group consisting of the police department, fire department, emergency medical services department, animal control department, health department, tax department, public works department, hazardous materials department, prosecutor's office, sheriff's office and municipal court.

18. A computer aided dispatching system as in claim 17, wherein said database further comprises a plurality of different databases separately maintained by different departments or agencies of the federal government and of the state in which said municipality is located.

19. A computer aided dispatching system as in claim 18, wherein said databases include the database of the National Crime Information Center.

20. A computer aided dispatching system as in claim 1, wherein said mobile data terminal includes a geographical locating device adapted to identify the geographical position of said mobile data terminal and to transmit a signal providing said geographical position to said central server.

21. A computer aided dispatching system as in claim 20, wherein said central server is adapted to provide said geographical position to a dispatching terminal in communication with said central server.

22. A computer aided dispatching system as in claim 20, wherein said central server is adapted to automatically dispatch said mobile data terminal to said location if said mobile data terminal is included among a group of other mobile data terminals associated with said dispatching system and said geographical position indicates that said mobile data terminal is closer to said location than said other mobile data terminals.

23. A method of dispatching a person or vehicle comprising:
receiving at a central server a communication corresponding to a location for providing services;
selecting from said central server, in response to said communication, a set of rules corresponding to said services;
querying from said central server a database based upon said rules for information relevant to said services and said location; and
automatically transmitting from said central server messages corresponding to said relevant information wirelessly to a mobile data terminal associated with said person or vehicle.

24. A method of dispatching a person or vehicle as in claim 23, further comprising transmitting said messages to said mobile data terminal while said person or vehicle is en route to said location.

25. A method of dispatching a person or vehicle as in claim 23, wherein said central server is associated with a municipality and said services are services of the municipality's emergency services personnel.

26. A method of dispatching a person or vehicle as in claim 25, wherein said emergency services personnel are emergency services personnel selected from the group consisting of police personnel, fire personnel and medical personnel.

27. A method of dispatching a person or vehicle as in claim 23, further comprising displaying said messages to a driver or passenger of said vehicle on a display of said mobile data terminal.

28. A method of dispatching a person or vehicle as in claim 27, further comprising providing an audio reproduction of said messages from said mobile data terminal for said driver or passenger.

29. A method of dispatching a person or vehicle as in claim 23, further comprising mounting said mobile data terminal on said person and providing an audio reproduction of said messages from said mobile data terminal for said person.

30. A method of dispatching a person or vehicle as in claim 29, further comprising displaying said messages to said person on a display of said mobile data terminal.

31. A method of dispatching a person or vehicle as in claim 23, wherein said communication is a signal from a dispatching terminal, in communication with said central server, to said mobile data terminal dispatching said person or vehicle to said location.

32. A method of dispatching a person or vehicle as in claim 23, wherein said communication is a signal from said mobile data terminal to a dispatching terminal, in communication with said central server, indicating that said person or vehicle is traveling, or will travel, to said location for providing said services.

33. A method of dispatching a person or vehicle as in claim 23, wherein said communication is a telephone call to a dispatching terminal, in communication with said central server, requesting said services.

34. A method of dispatching a person or vehicle as in claim 23, further comprising selecting from said central server a second set of rules corresponding to said relevant information, further querying from said central server said database based upon said second set of rules for further information relevant to said relevant information and automatically transmitting from said central server further messages corresponding to said further relevant information wirelessly to said mobile data terminal.

35. A method of dispatching a person or vehicle as in claim 34, further comprising transmitting said further messages to said mobile data terminal while said person or vehicle is in route to said location.

36. A method of dispatching a person or vehicle as in claim 23, wherein said database comprises a plurality of independent databases separately maintained by different entities and connected by a network.

37. A method of dispatching a person or vehicle as in claim 36, wherein said network comprises the Internet.

38. A method of dispatching a person or vehicle as in claim 25, wherein said database comprises a plurality of different databases separately maintained by different departments or agencies of said municipality.

39. A method of dispatching a person or vehicle as in claim 38, wherein said different departments or agencies comprises a plurality of departments or agencies selected from the group consisting of the police department, fire department, emergency medical services department, animal control department, health department, tax department, public works department, hazardous materials department, prosecutor's office, sheriff's office and municipal court.

40. A method of dispatching a person or vehicle as in claim 39, wherein said database further comprises a plurality of different databases separately maintained by different departments or agencies of the federal government and of the state in which said municipality is located.

41. A method of dispatching a person or vehicle as in claim 40, wherein said databases include the database of the National Crime Information Center.

42. A method of dispatching a person or vehicle as in claim 23, further comprising identifying, using a geographical locating device associated with said mobile data terminal, the geographical position of said mobile data terminal and transmitting a signal providing said geographical position from said mobile data terminal to said central server.

43. A method of dispatching a person or vehicle as in claim 42, further comprising providing said geographical position to a dispatching terminal in communication with said central server.

44. A method of dispatching a person or vehicle as in claim 42, further comprising automatically dispatching from said central server said mobile data terminal to said location if said mobile data terminal is included among a group of other mobile data terminals associated with said central server and said geographical position indicates that said mobile data terminal is closer to said location than said other mobile data terminals.

45. A computer readable medium having computer executable software code stored on said medium, said code comprising instructions for causing a central server of a system for dispatching a person or vehicle to perform the steps of (1) receiving a communication corresponding to a location for providing services, (2) selecting in response to said communication a set of rules corresponding to said services, (3) querying a database based upon said rules for information relevant to said services and said location, and (4) automatically transmitting messages corresponding to said relevant information wirelessly to a mobile data terminal associated with said person or vehicle.

46. A computer readable medium as in claim 45, wherein said code further comprises instructions for causing said central server to transmit said messages to said mobile data terminal while said person or vehicle is en route to said location.

47. A computer readable medium as in claim 23, wherein said dispatching system is associated with a municipality and said services are services of the municipality's emergency services personnel.

48. A computer readable medium as in claim 47, wherein said emergency services personnel are emergency services personnel selected from the group consisting of police personnel, fire personnel and medical personnel.

49. A computer readable medium as in claim 45, wherein said code further comprises instructions for causing said central server to cause said mobile data terminal to display said messages on a display of said mobile data terminal.

50. A computer readable medium as in claim 49, wherein said code further comprises instructions for causing said central server to cause said mobile data terminal to provide an audio reproduction of said messages.

51. A computer readable medium as in claim 45, wherein said mobile data terminal is mounted on said person and said code further comprises instructions for causing said central server to cause said mobile data terminal to provide an audio reproduction of said messages.

52. A computer readable medium as in claim 51, wherein said code further comprises instructions for causing said central server to cause said mobile data terminal to display said messages on a display of said mobile data terminal.

53. A computer readable medium as in claim 45, wherein said communication is a signal from a dispatching terminal, in communication with said central server, to said mobile data terminal dispatching said person or vehicle to said location.

54. A computer readable medium as in claim 45, wherein said communication is a signal from said mobile data terminal to a dispatching terminal, in communication with said central server, indicating that said person or vehicle is traveling, or will travel, to said location for providing said services.

55. A computer readable medium as in claim 45, wherein said communication is a telephone call to a dispatching terminal, in communication with said central server, requesting said services.

56. A computer readable medium as in claim 45, wherein said code further comprises instructions for causing said central server to select a second set of rules corresponding to said relevant information, further query said database based upon said second set of rules for further information relevant to said relevant information and to automatically transmit from said central server further messages corresponding to said further relevant information wirelessly to said mobile data terminal.

57. A computer readable medium as in claim 56, wherein said code further comprises instructions for causing said central server to transmit said further messages to said mobile data terminal while said person or vehicle is in route to said location.

58. A computer readable medium as in claim 45, wherein said database comprises a plurality of independent databases separately maintained by different entities and connected by a network.

59. A computer readable medium as in claim 58, wherein said network comprises the Internet.

60. A computer readable medium as in claim 47, wherein said database comprises a plurality of different databases separately maintained by different departments or agencies of said municipality.

61. A computer readable medium as in claim is 60, wherein said different departments or agencies comprises a plurality of departments or agencies selected from the group consisting of the police department, fire department, emergency medical services department, animal control department, health department, tax department, public works department, hazardous materials department, prosecutor's office, sheriff's office and municipal court.

62. A computer readable medium as in claim 61, wherein said database further comprises a plurality of different databases separately maintained by different departments or agencies of the federal government and of the state in which said municipality is located.

63. A computer readable medium as in claim 62, wherein said databases include the database of the National Crime Information Center.

64. A computer readable medium as in claim 45, wherein said code further comprises instructions for causing said central server to identify, using a signal from a geographical locating device associated with said mobile data terminal, the geographical position of said mobile data terminal.

65. A computer readable medium as in claim 64, wherein said code further comprises instructions for causing said central server to provide said geographical position to a dispatching terminal in communication with said central server.

66. A computer readable medium as in claim 64, wherein said code further comprises code for causing said central server to automatically dispatch said mobile data terminal to said location if said mobile data terminal is included among a group of other mobile data terminals associated with said dispatching system and said geographical position indicates that said mobile data terminal is closer to said location than said other mobile data terminals.
